(19) United States
(12) Patent Application Publication
(10) Pub. No.: US 2016/0257157 A1
(43) Pub. Date: Sep. 8, 2016

(54) A Method and Apparatus for Automatic Variable Creasing with a Digital Creaser

(71) Applicant: GUANGZHOU DUMOR AUTOMATION SYSTEM CO., LTD., Guangzhou, Guangdong (CN)

(72) Inventors: Shumin Zhang, Guangzhou (CN); Liang Xu, Guangzhou (CN); Shaosong Hou, Guangzhou (CN); Changcheng Tang, Guangzhou (CN)

(21) Appl. No.: 14/394,924

(22) PCT Filed: Jan. 7, 2014
(86) PCT No.: PCT/CN2014/070192

§ 371 Date: Oct. 16, 2014

(30) Foreign Application Priority Data
Apr. 15, 2013 (CN) 201310130637.8

(51) Int. Cl. B42C 13/00

(52) U.S. Cl. CPC B42C 13/003

(57) ABSTRACT

The present invention discloses a method and apparatus for an automatic variable creasing with a digital creaser. This method includes the following steps: determining a zero point position C0, a starting location C1, and a variable parameter X; transferring a paper sheet i to the creasing area of an creaser, and calculating creasing position P of the paper sheet according to the zero point position C0, the starting location C1, the variable parameter X and i, making an crease at the creasing position P. This apparatus is composed of a parameter obtaining module, a detection module, a transferring module, an creasing module, and a processing & control module. The present invention realizes the object of automatic variable creasing, making the variable creasing efficiency higher, the precision higher, facilitating binding and page turning of thick paper books. The apparatus of the present invention for automatic variable creasing with a digital creaser is specially designed for the said automatic variable creasing method. The present invention can be used in book sheet creasing.

### FIELD OF THE INVENTION

The present invention relates to the field of electromechanical control, in particular to a method and an apparatus for automatic variable creasing with a digital creaser

### BACKGROUND OF THE INVENTION

With the modernization of industry today, various kinds of book bindings require higher efficiency, practicability, attractiveness and high grade, so that the requirements for bookmaking have become higher. In the prior art, there are also descriptions of automatic creasers, as shown in FIG. 2, the principle of which is approximately as follows: a creasing die 3, which can open and close by acting up and down, is arranged between the two side plates of the creaser. In both the front and the rear of the creasing die 3, there are arranged a roller set 2 respectively, and the space between the roller sets both in the front and in the rear, is the creasing area of the creaser. Driven by the power installation, roller set 2 conveys paper sheet 1 to the creasing area, locates paper sheet 1 to a fixed position, the creasing die 3 is controlled by the processor to make a crease on the paper sheet 1, and then the roller set 2 rotates again to output the paper sheet 1. At this time, the printed paper sheet, as shown in FIG. 4, is creased at the creasing position P. The binding personnel will superimpose the multiple sheets of paper so creased in order, offset print them immediately or after enclosing and bind them into a book as shown in FIG. 3. Evidently, due to the thickness of a paper sheet itself, if the creasing positions of paper sheets overlap on the same place, it is not beneficial to page turning. Especially for thick paper books, the shortcoming is more prominent. Therefore, the digital creasing method, which is conducted only on the same position, is not suitable to the paper sheet creasing of thick paper books. This kind of book requires malposed creasing positions (creasing positions of adjacent paper sheets are biased sequentially, in convenience of page turning). Presently, this kind of malposed creasing is realized manually. This kind of method has also the shortcomings including high cost and low efficiency, where precision is difficult to control; thus it is not beneficial to mass

### SUMMARY OF THE INVENTION

The present invention aims to provide a method for automatic variable creasing with a digital creaser, in order to solve the technical problems mentioned above.

The present invention aims also to disclose an apparatus for an automatic variable creasing with a digital creaser.

The technical solution adopted by the present invention is: a method for automatic variable creasing with a digital creaser, comprising the following steps:

S1, determining a zero point position C0, a starting location C1, and a variable parameter X;

S2, transferring a paper sheet having a sequence number (i) to the creasing area of the creaser, and calculating a paper sheet creasing position P according to the zero point position C0, the starting location C1, the variable parameter X and the sequence number (i), and making a crease at the creasing position P.

Furthermore, in the said step S2, the calculation of the creasing position P is determined by the formula:

P=C0+C1+(i−1)8X.

Furthermore, in said step S1, determining the total number of paper sheets N is also included.

Furthermore, in the said step S2, the calculation of the creasing position P is determined by the formula:

$$P = \{ \begin{matrix}C 0 + C 1 + {( i - 1 )}^{*} X & ( i \leq \frac{N + 1}{2} ) \\ C 0 + C 1 + {( N - i )}^{*} X & ( i > \frac{N + 1}{2} )\end{matrix} .$$

In addition, the apparatus for automatic variable creasing with a digital creaser, comprises the following modules:
a parameter obtaining module, for determining the zero point position C0, the starting location C1 and the variable parameter X, and transmitting the parameters C0, C1 and X to a processing and control module;
a detection module, including a paper sheet position detecting submodule, for detecting the paper sheet position and transmitting it to the processing and control module;
a transferring module, for receiving the control commands from the processing and control module, and transferring paper sheets to the creasing area of the creaser;
a creasing module arranged in the creasing areas of the creaser, for receiving the control commands from the processing and control module, and making creases at the creasing positions P;
wherein said processing and control module calculates the creasing position P of paper sheets according to the individual parameters determined by the parameter obtaining module, computing the paper sheet creasing position P, controls the transferring module in transferring paper sheets, and controls the creasing module to make a crease at the creasing position P of a paper sheet.

Furthermore, said parameter obtaining module also includes: a total paper sheet number obtaining submodule, for determining the total number N of paper sheets, and transmitting parameter N to the processing and control module.

Furthermore, said detection module also includes: a current sheet number detecting submodule, four detecting the paper sheet currently entering the creaser, determining the sequence number (i) of the paper sheet entering the creasing area of the creaser, and transmitting the sequence number (i) to the processing and control module.

Furthermore, the said transferring module includes a roller set connected with a stepping motor, said stepping motor controlled by the processing and control module.

Furthermore, said creasing module is composed of an open-close mechanism by moving up and down and a creasing die connected with the mechanism. Said open-close mechanism comprises a creasing motor and an eccentric cam connected with the creasing motor, wherein the eccentric cam engages with the creasing die, wherein the creasing motor is controlled by the processing and control module.

The advantageous effects of the present invention are as follows. The present invention adopts the method for automatic variable creasing with a digital creaser. Before creasing, positions of individual paper sheets and variable parameters are determined; creases are made before the creasing positions of individual paper sheet are determined. The subsequent paper sheet creasing position then changes with the influence of the variable parameter X. With the unremitting work of the creaser, multi paper sheets with different creasing positions are printed out successively. Therefore, the purpose of automatic variable creasing is realised, making the variable creasing efficiency and precision higher, and facilitating the book binding and page turning of thick paper books. The apparatus of the present invention for automatic variable creasing with a digital creaser is specially designed for the said method for automatic variable creasing. The present invention can be used in book creasing.

### BRIEF DESCRIPTION OF DRAWINGS

A detailed description of the embodiments of the present invention is made below in combination with the attached drawings.

FIG. 1 is a flow chart of the method for automatic variable creasing with a digital creaser according to the present invention.

FIG. 2 is a structural schematic diagram of an automatic creaser utilizing existing technology.

FIG. 3 is a schematic diagram of a book bound by using existing creasing technology.

FIG. 4 is a schematic diagram of the positions on the paper sheets of part of the parameters used in the present invention.

FIG. 5 is a schematic diagram of the first kind of bookbinding according to the method of the present invention.

FIG. 6 is a schematic diagram of the second kind of bookbinding according to the method of the present invention.

FIG. 7 is a schematic diagram of the third kind of bookbinding according to the method of the present invention.

FIG. 8 is a schematic diagram of the fourth kind of bookbinding according to the method of the present invention.

FIG. 9 is the structural block diagram of the apparatus for automatic variable creasing with digital creaser according to the present invention.

### DETAILED DESCRIPTION OF THE EMBODIMENTS

It should be noted that the embodiments in this application and the characteristics of the embodiments can be combined without conflict.

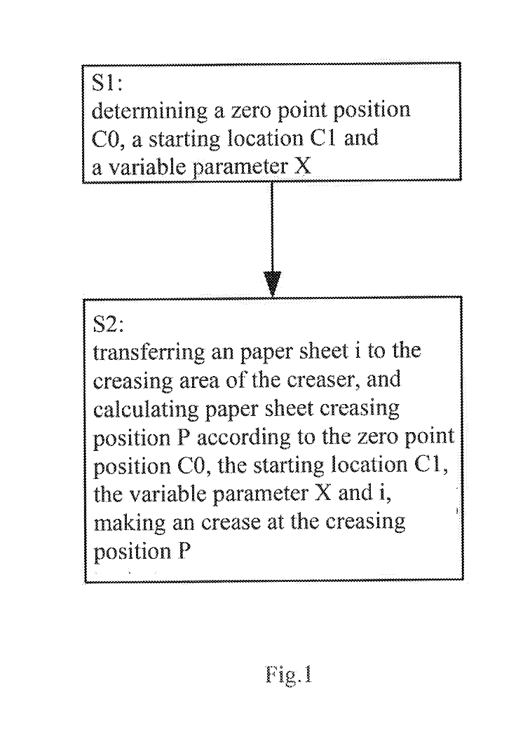

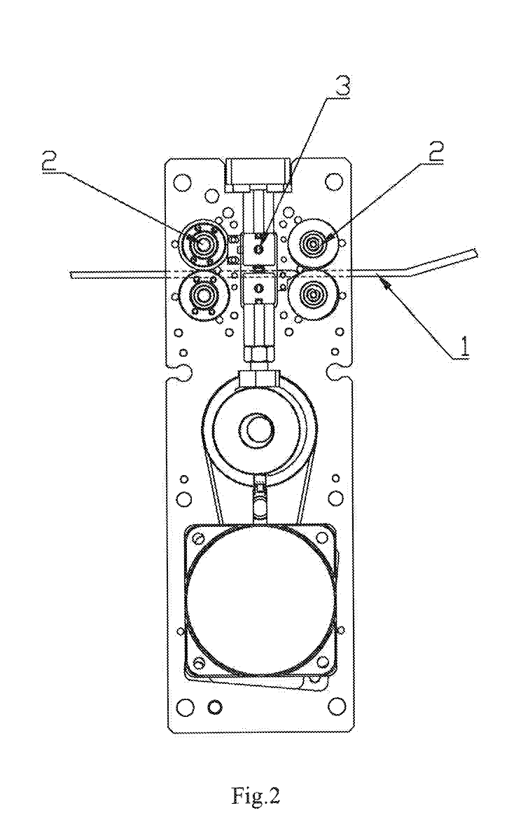

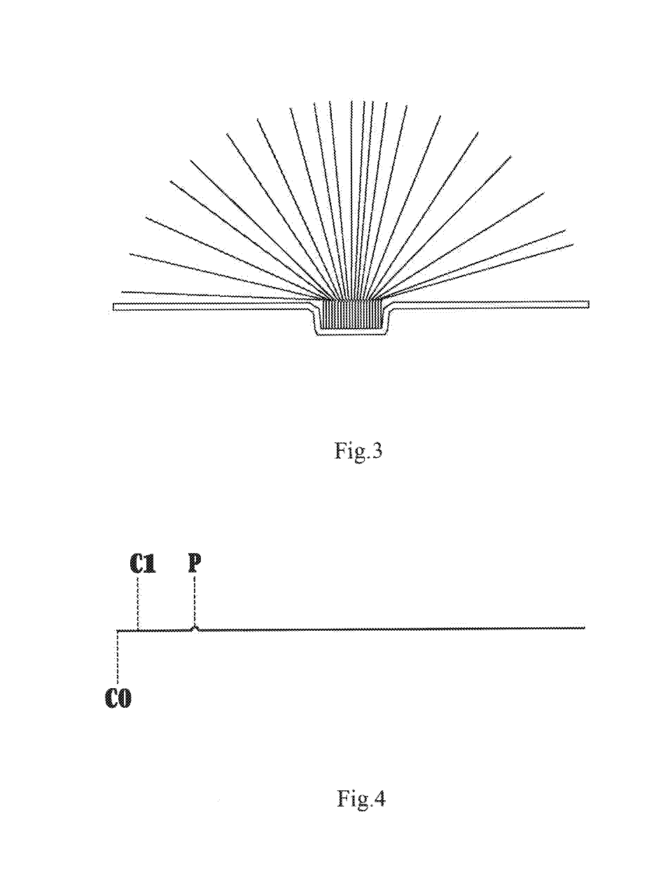

Referring to FIGS. 1 and 4, the steps of this method for automatic variable creasing with a digital creaser according to the present invention comprise step 1 and step 2.

Step 1 includes determining a zero point position C0, a starting location C1, and a variable parameter X, wherein parameters C0, C1 and X are all numerical values. C0 and C1 correspond to the position of paper sheets in the creasing areas. For example, when the zero point position of a paper sheet is arranged at the head end, then C0 equals 0; when zero point position is set a certain distance off the head end, then C0 is larger than 0. Parameter C1 is used to determine the creasing position P of the first paper sheet entering the digital creaser. The parameter C1 may be any real number, for example, when the creasing position P of the first paper sheet coincides with zero point position, then C1 equals 0. In the step S1, the zero point position C0, the starting location C1 and the variable parameter X may be set by default, or set through entering parameters into the computer system of the digital creaser by a user every time. The variable parameter X may be any real number (including positive numbers and negative numbers).

Step 2 includes transferring a paper sheet (i) to the creasing area of the creaser, and calculating paper sheet creasing position P according to the zero point position C0, the starting location C1, the variable parameter X and (i), making a crease at the creasing position P, wherein the introduction of the variable X enables that different papers may have different creasing positions. The value of the variable parameter X is determined according to the thickness of a paper sheet. The algorithmic method of creasing position P is set as required, for instance, by arithmetic progressive increase, isometric progressive increase, arithmetic degression, and the like.

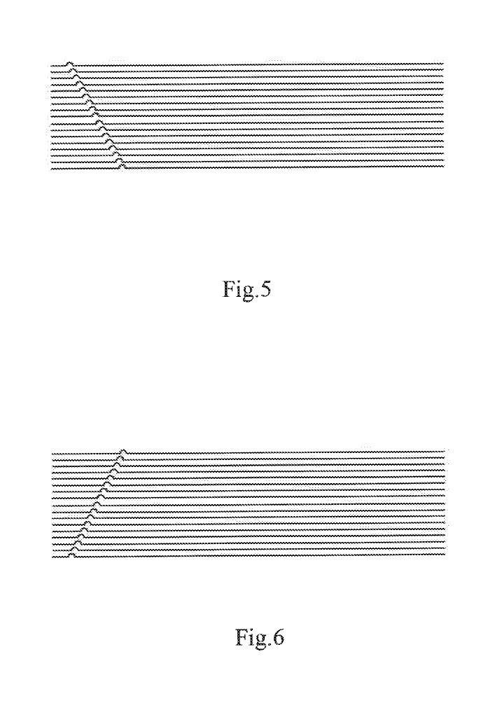

Referring to FIGS. 5 and 6, as shown in FIG. 5, the left end face of the book is the spine; and the bulge part within the paper sheet is the creasing of the paper sheets. The number of paper sheets is in increasing order from top to bottom. The numerical value of creasing position P of the first paper is the minimum, and the creasing of the first page is the nearest to the book spine, while the numerical value of creasing position P of the last paper is the maximum, and the creasing of the last paper is the furthest from the book spine. As shown in FIG. 6, the left side of the book is the spine; the bulge part within the paper sheet is the creasing of the paper sheets. The number of paper sheet is in increasing order from top to bottom. The numerical value of creasing position P of the first paper is the maximum, and the creasing of the first paper is the furthest from the book spine, while the numerical value of creasing position P of the last paper is the minimum, and the creasing of the last paper is the nearest to the hook spine.

The method for automatic variable creasing with a digital creaser according to the first embodiment of the present invention, uses, in said Step S2, the following formula for computing the creasing position: P=C0+C1+(i−1)*X. The creasing positions P of individual paper sheets form an arithmetic increasing/decreasing sequence. When X is a positive number, the method is implemented and the schematic diagram of the bound book paper sheets is shown in FIG. 5. When X is a negative number, the method is implemented and the schematic diagram of the bound book paper sheets is shown in FIG. 6. When X is 0, the creasing position is constant.

Determining the total number N of paper sheets can also be included in Step S1. The total number of paper sheets can either be set by default, or set by a user at each time through entering parameters into the computer system of the digital creaser. Generally, the total sheet number N equals to the number of pages in a book. In case of batch creasing, when the sequence number of paper sheets transferred is larger than N, (i) can be reset as 1, namely, continuous variable creasing for mass production of multiple hooks is realized.

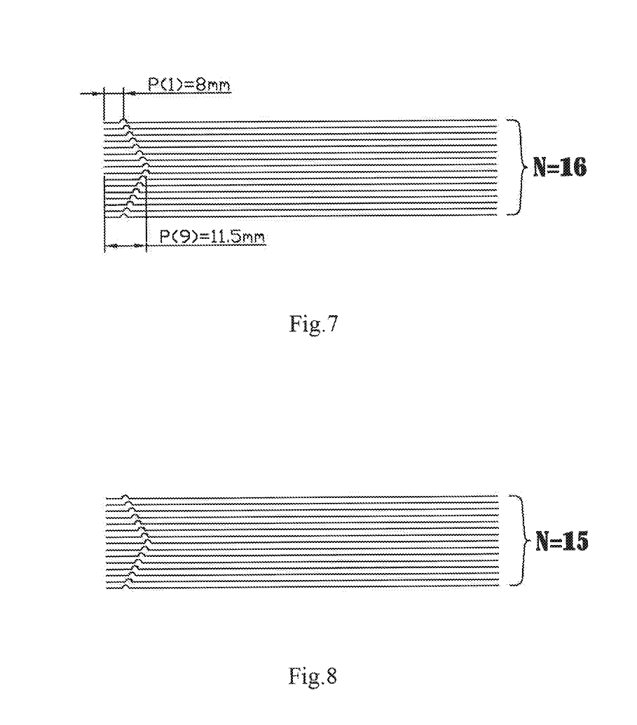

Referring to FIGS. 7 and 8, the left end face of the book is the spine, and the bulge part of a paper sheet is the creasing of the paper sheet. The sequence of paper sheet number is in increasing order. Both FIG. 7 and FIG. 8 adopt reciprocating creasing, namely, the numerical value of creasing position P of the first paper and the last paper is the minimum, and the creasing of the first paper is the nearest to the book spine, while the numerical value of creasing position P of one or two of papers in the middle is the maximum, and the creasing thereof is the furthest from the hook spine.

The second embodiment of the method of the present invention for automatic variable creasing with a digital creaser uses, in step S2, an algorithmic method of creasing position P according to the following formula:

$$P = \{ \begin{matrix}C 0 + C 1 + {( i - 1 )}^{*} X & ( i \leq \frac{N + 1}{2} ) \\ C 0 + C 1 + {( N - i )}^{*} X & ( i > \frac{N + 1}{2} )\end{matrix} .$$

When X is a positive number, and N is an even number, the method is implemented and the schematic diagram of the book paper sheets bound in sequence is shown in FIG. 7. When X is a positive number, and N is an odd number, the method is implemented and the schematic diagram of the book paper sheets bounded in sequence is shown in FIG. 8.

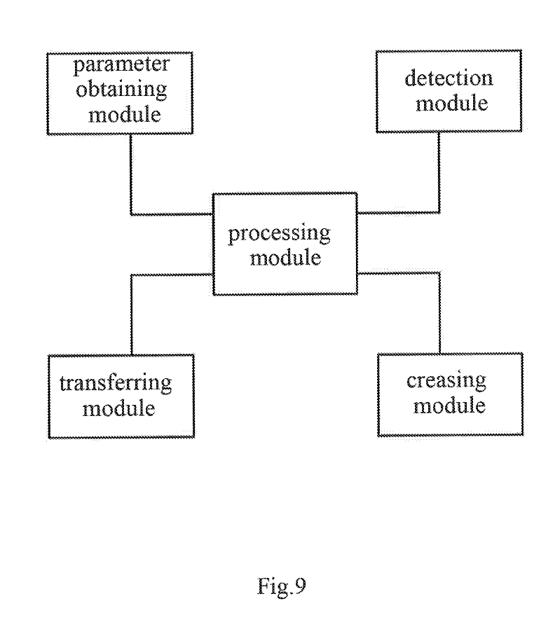

Referring to FIG. 9, an apparatus for automatic variable creasing with a digital creaser comprises:
a parameter obtaining module, for determining a zero point position C0, a starting location C1 and a variable parameter X. and transmitting parameters C0, C1 and X to the processing and control module. In a concrete embodiment, the parameter obtaining module can be realized by keys and a display screen, and a user inputs individual parameters on the display screen by the keys. The parameter obtaining module may also store various parameter values set by default in its memory.

A detection module is also included in the apparatus, and the detection module includes a paper sheet position detecting submodule, used for detecting paper sheet position and transmitting it to the processing and control module.

In a concrete embodiment, the detection module may be an optical sensor, a toggle switch, camera and the like, which is responsible mainly for detecting paper sheet entry signal or paper sheet position signal, and transmitting the signal to the processing and control module.

A transferring module is also included in the apparatus, and the transferring module is used for receiving the control command from the processing and control module, and transferring paper sheets to the creasing area of the creaser.

In a concrete embodiment, the transferring module includes a roller set connected with a stepping motor, wherein the stepping motor is controlled by the processing and control module. As a preferred embodiment, a rubber roller set is selected as the roller set.

A creasing module arranged in the creasing area of the creaser is also included in the apparatus, and the creasing module is used for receiving the control command from the processing and control module, and making a crease at the creasing position P of a paper sheet. In a concrete embodiment, the creasing module is composed of an open-close mechanism which acts up and down, and a creasing die coupled with the mechanism. The open-close mechanism comprises a creasing motor and an eccentric cam connected with the creasing motor. The eccentric cam engages with the creasing die, and the creasing motor is controlled by the processing and control module.

The processing and control module is used for calculating the creasing position P of paper sheets, controlling the transferring module to transfer the paper sheets, and controlling creasing modules to making creases at the creasing positions P of paper sheets, according to various parameters determined by the parameter obtaining module. In a concrete embodiment, the processing and control module may be a single-chip microprocessor.

Furthermore, said parameter obtaining module also includes: a total sheet number obtaining submodule, used for determining total number of paper sheets N and transmitting it to the processing and control module. Generally, the total sheet number N is the number of pages in a book. According to the total sheet number N, when the sequence number (i) of a paper sheet entering creasing area is larger than N, (i) will be reset as 1 by the processing module, and the continuous variable creasing of multiple books can be realized.

Furthermore, said detection module also includes: a current sheet number detecting submodule, used for detecting the paper sheet currently entering the creaser, determining sequence number (i) of the paper sheets entering the creasing areas of the creaser, and transmitting the parameter (i) to the processing and control module. In a concrete embodiment, the current sheet number detecting submodule may utilize memory, where the sequence number (i) of a current paper sheet is stored, where the module compares it with the total sheet number N. When i is larger than N, (i) is reset as 1.

Taking a book with 16 pages and reciprocating creasing (referring to FIG. 7) for example, a detailed description of the work flow of the method and apparatus for automatic variable creasing with a digital creaser according to the present invention is made below. First, a user inputs the concrete numerical values of the zero point position C0, the starting location C1, the variable parameter X, and the total sheet number N, sets C0=0 mm, C1=8 mm, X=0.5 mm and N=16, and selects the reciprocating creasing mode, on a user's display window of a digital creaser (namely, a parameter obtaining apparatus, usually a control key and a display).

Second, a plurality of paper sheets are put into the digital creaser, and a single-chip microprocessor will control the stepping motor to drive the rubber roller set to transfer the first paper sheet to the creasing area. Third, an optical sensor detects the paper sheet position, the paper sheet sequence number (i)=1 is determined, and the paper sheet sequence number (i) is stored temporarily in a storage. Fourth, the single-chip microprocessor, according to the formula of creasing position P of reciprocating creasing, calculates the creasing position P of the first paper sheet. Fifth, the rubber roller set, controlled by the single-chip microprocessor, rotates and transfers the first paper sheet to the creasing position P. Sixth, the creasing die, under the control of the single-chip microprocessor, makes a crease on the first paper sheet. Seventh, the rubber roller set rotates and outputs the first paper sheet, and transfers the second paper sheet into the creasing area. This cycle continues. When the 17th paper sheet is transferred in, as 17 is larger than the total sheet number N (N=16), the sequence number of the paper sheet will be reset as 1 by the detection module, and stored in the memory.

With the continuous work of the creaser, a plurality of sheets with different creasing positions will be output successively. According to the formula of the reciprocating creasing, the creasing positions of the first 17 paper sheets are as follows respectively:

P(1)=C0+C1+(i−1)*X=0+8+(1−1)*0.5=8 mm;

P(2)=C0+C1+(i−1)*X=0+8+(2−1)*0.5=8.5 mm;

P(3)=C0+C1+(i−1)*X=0+8+(3−1)*0.5=9 mm;

P(4)=C0+C1+(i−1)*X=0+8±(4−1)*0.5=9.5 mm;

P(5)=C0+C1+(i−1)*X=0+8+(5−1)*0.5=10 mm;

P(6)=C0+C1+(i−1)*X=0+8+(6−1)*0.5=10.5 mm;

P(7)=C0+C1+(i−1)*X=0+8+(7−1)*0.5=11 mm;

P(8)=C0+C1+(i−1)*X=0+8+(8−1)*0.5=11.5 mm;

P(9)=C0+C1+(i−1)*X=0+8+(16−9)* 0.5=11.5 mm;

P(10)=C0+C1+(i−1)*X=0+8+(16−10)*0.5=11 mm;

P(11)=C0+C1+(i−1)*X=0+8+(16−11)*0.5-10.5 mm;

P(12)=C0+C1+(i−1)*X=0+8+(16−12)*0.5=10 mm;

P(13)=C0+C1+(i−1)*X=0+8+(16−13)*0.5=9.5 mm;

P(14)=C0+C1+(i−1)*X=0+8+(16−14)*0.5=9 mm;

P(15)=C0+C1+(i−1)*X=0+8+(16−15)*0.5=8.5 mm;

P(16)=C0+C1+(i−1)*X=0+8+(16−16)*0.5=8 mm;

P(17)=C0+C1+(i−1)*X=0+8+(1−1)*0.5-8 mm.

Similarly, the apparatus can also realise arithmetic increasing/decreasing creasing (referring to FIG. 5/FIG. 6), where the computation of creasing position P applies to the formula: P=C0+C1+(i−1)*X, which will not be repeated herein.

Detailed description of the preferred embodiment of the present invention is made above, however, the present invention is not limited to said embodiment, technical personnel skilled in the art may make various equivalent variation or replacement without departing the spirit of the present invention. All the equivalent variation or replacement is within the scope limited by the claims of the application.

1. A method for automatic variable creasing with a digital creaser, characterized by comprising the following steps:
(1) determining a zero point position C0, a starting location C1, and a variable parameter X;
(2) transferring a paper sheet having a sequence number to the creasing area of an the creaser, and calculating a creasing position P of the paper sheet according to the zero point position C0, the starting location C1, the variable parameter X, and the sequence number (i), and making a crease at the creasing position P.

2. The method for automatic variable creasing with a digital creaser according to claim 1, wherein the calculation of the creasing position P in step (2) is determined by the formula:
P=C0+C1+(i−1)*X.

3. The method for automatic variable creasing with a digital creaser according to claim 1, wherein step (1) further includes determining a total number of paper sheets N.

4. The method for automatic variable creasing with a digital creaser according to claim 3, wherein the calculation of the creasing position P in step (2) is determined by the formula:
$$P = \{ \begin{matrix}C 0 + C 1 + {( i - 1 )}^{*} X & ( i \leq \frac{N + 1}{2} ) \\ C 0 + C 1 + {( N - i )}^{*} X & ( i > \frac{N + 1}{2} )\end{matrix} .$$

5. An apparatus for automatic variable creasing with a digital creaser according to the method of claim 3, the apparatus comprising the following modules:
a parameter obtaining module for determining the zero point position C0, the starting location C1, and the variable parameter X, and transmitting the parameters C0, C1, and X to a processing and control module;
a detection module, including a paper sheet position detecting submodule, for detecting the paper sheet position and transmitting it to the processing and control module;
a transferring module, for receiving the control commands from the processing and control module, and transferring paper sheets to the creasing area of the creaser;
a creasing module arranged in the creasing area of the creaser, for receiving the control commands from the processing and control module, and making creases at the creasing position P;
a wherein said processing and control module calculates the creasing position P of paper sheets according to the individual parameters determined by the parameter obtaining module, controls the transferring module to transfer paper sheets, and controls the creasing module to make a crease at the creasing position P of the paper sheet.

6. The apparatus for automatic variable creasing with a digital creaser according to claim 5, wherein the parameter obtaining module also further includes: a total sheet number obtaining submodule, for determining the total number N of paper sheets, and transmitting parameter N to the processing and control module.

7. The apparatus for automatic variable creasing with a digital creaser according to claim 5, characterized in that:
the detection module further includes: a current sheet number detecting submodule, used for detecting the paper sheet currently entering the creaser, determining the sequence number of the paper sheet entering the creasing area of the creaser, and transmitting the sequence number to the processing and control module.

8. The apparatus for automatic variable creasing with a digital creaser according to claim 7, wherein the transferring module includes a roller set connected with a stepping motor, wherein the stepping motor is controlled by the processing and control module.

9. The apparatus for automatic variable creasing with a digital creaser according to claim 8, wherein the creasing module is composed of an open-close mechanism which acts up and down and a creasing die connected with the mechanism, wherein said open-close mechanism comprises a creasing motor and an eccentric cam connected with the creasing motor, wherein the eccentric cam engages with the creasing die, and wherein the creasing motor is controlled by the processing and control module.
